(19) United States
(12) Patent Application Publication
(10) Pub. No.: US 2026/0329072 A1
(43) Pub. Date: Oct. 22, 2026

(54) Approach for a Dual Field of View Lens Using Hybrid Metaoptic Modules

(71) Applicant: NORTHROP GRUMMAN SYSTEMS CORPORATION, FALLS CHURCH, VA (US)

(72) Inventors: Arthur B. O'Connor, Falls Church, VA (US); Philip W.C. Hon, Falls Church, VA (US); Shu-i Wang, Falls Church, VA (US)

(21) Appl. No.: 19/092,078

(22) Filed: Mar. 27, 2025

(51) Int. Cl. G02B 26/08; G02B 3/00; G02B 3/08; G02B 23/12; H04N 23/11; H04N 23/55

(52) U.S. Cl. CPC G02B 26/0875; G02B 3/08; G02B 23/12; H04N 23/11; H04N 23/55; G02B 2003/0093

(57) ABSTRACT

A telescope including a primary lens assembly operable to collect and focus a light beam along an optical axis and a swappable FOV lens module positioned along the optical axis. The FOV module includes a hybrid FOV lens assembly having a plurality of lens that are operable to focus the light beam, where at least one of the plurality of lenses is a planar metalens. An actuator moves the wide FOV module into and out of the optical axis to put the telescope into a wide FOV mode when the FOV module is in the optical axis and into a narrow FOV mode when the FOV module is not in the optical axis, or put the telescope into a narrow FOV mode when the FOV module is in the optical axis and into a wide FOV mode when the FOV module is not in the optical axis.

### GOVERNMENT CLAUSE

This invention was made with Government support under Contract No. FA8650-22-D-5814 awarded by the Air Force Research Laboratory. The Government has certain rights in this invention.

### BACKGROUND

### Field

This disclosure relates generally to a dual field of view (FOV) telescope and, more particularly, to a dual FOV telescope including a swappable FOV module that has a hybrid lens assembly with planar metalenses and refractive lenses, where the swappable FOV module is movable into and out of the optical path.

### Discussion of the Related Art

For various optical telescopes and other optical systems and devices, it is often desirable to provide a continuous zoom capability that allows a continuum of different fields of view (FOV). For example, it is often desirable to provide a range of wide FOVs for situational awareness and identifying an object of interest and a range of narrower FOV for more precise location identification of the object with higher resolution and magnification. However, a continuous zoom lens is very difficult to achieve because such lenses typically require a very challenging lens design, bulky mechanical support necessary to move lens modules along the optical axis, are prohibitively large, and require complex athermal supporting structures.

It is known to provide a finite step lens focus between a wide FOV and a narrow FOV as a compromise, which often requires rapid switching between the wide and narrow FOVs in certain applications. This switching between FOVs is commonly accomplished with the removal and addition of optics into and out of the optical axis with rotation, translation or other actuation mechanisms. The actuation speed of the optics is directly affected by the weight of the optics module. Other designs employ beam splitters or movable mirrors that separate the input beam into one optical channel for wide FOV and into another optical channel for narrow FOV. However, these designs require higher volume, higher part count, loss of beam power in each split channel, etc.

Optical metamaterials are artificially engineered materials that obtain their properties primarily from their internal microstructure, rather than their chemical composition. Optical metamaterials have optical properties that are a function of the material's native optical property (refractive index), subwavelength unit cell element motif, properties of the incident light, such as its incidence angle and polarization, and the configuration of its unit cells (periodic/aperiodic) rather than just the material's native chemical composition (refractive index). 2-D metamaterials, also known as metasurfaces, can be designed and fabricated as structural units to achieve desired diffractive optical properties and functionalities, such as focusing light with low loss, where such metasurfaces are sometimes referred to as metalenses.

Metasurfaces or metalenses are ultra-thin flat optics that can be fabricated for visible and IR imaging. The unit cells or meta-atoms for these metalenses may include motifs such as pillars, holes, rings, crosses, etc. on the order of λ₀/4 in size periodically arranged on a transparent or reflective substrate, where the planar optic out of plane dimension can be on the order of λ₀, but could be smaller if the material index is large. The ability to fabricate optical quality spectrally wideband flat metalenses and metamirrors (reflective elements) with good achromatic performance using conventional micro/nano-electronic fabrication techniques has been demonstrated in the art.

### BRIEF DESCRIPTION OF THE DRAWINGS

FIG. 1 is an illustration of a telescope including a swappable FOV module having a metalens;

FIG. 2 is an illustration of the telescope shown in FIG. 1 with the swappable FOV module removed from the optical axis;

FIG. 3 is a side view of the metalens separated from the wide FOV module; and

FIG. 4 is a rear view of the metalens.

### DETAILED DESCRIPTION OF THE EMBODIMENTS

The following discussion of the embodiments of the disclosure directed to a dual FOV telescope including a swappable FOV module that has a hybrid lens assembly with planar metalenses and refractive lenses is merely exemplary in nature, and is in no way intended to limit the disclosure or its applications or uses.

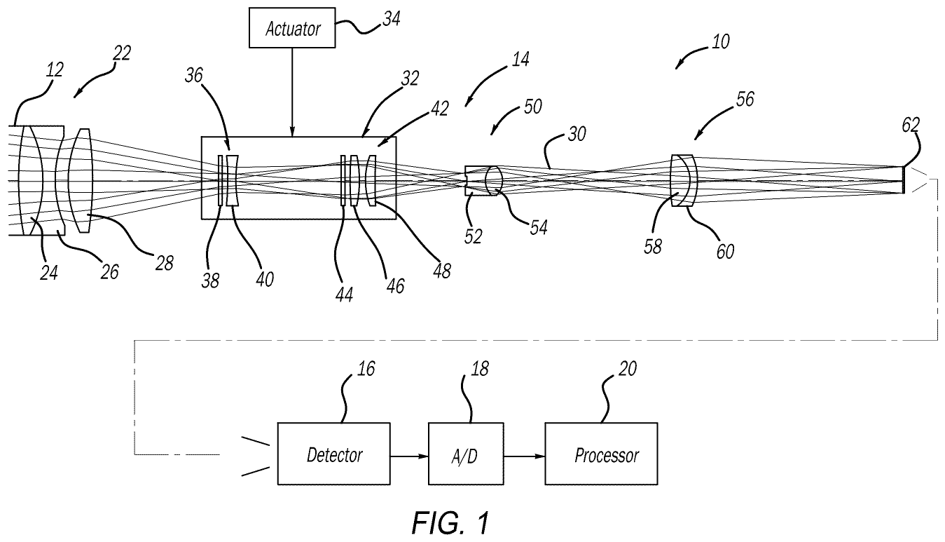

FIG. 1 is an illustration of a dual field-of-view (DFOV) telescope 10 including an aperture 12 and a lens assembly 14 that collects and focuses light received through the aperture 12, which is typically from a far distance and thus may be collimated. A light beam 30 propagates along an optical axis through the telescope 10 and is focused by the lens assembly 14 at a focal plane 62 onto a detector 16 including, for example, an array of photodiodes, charge-coupled devices (CCD) or detector/focal plane array sensitive to the operating wavelength that provides electrical signals to an analog-to-digital converter (ADC) 18 that provides digital signals to a processor 20 that prepares images therefrom. The detector 16 and processor 20 can be configured to detect and process light of any suitable wavelength, such as infrared or visible light. The lens assembly 14 includes a primary or objective lens group 22 of a shorter focal length having three conventional refractive lenses, namely, in order from the aperture 12, a convex refractive lens 24, a concave refractive lens 26 and convex refractive lens 28, that provide an intermediate focus of the beam 30 propagating through the telescope 10. In other designs, the lens group 22 could have any suitable number of lenses and could include reflective lenses.

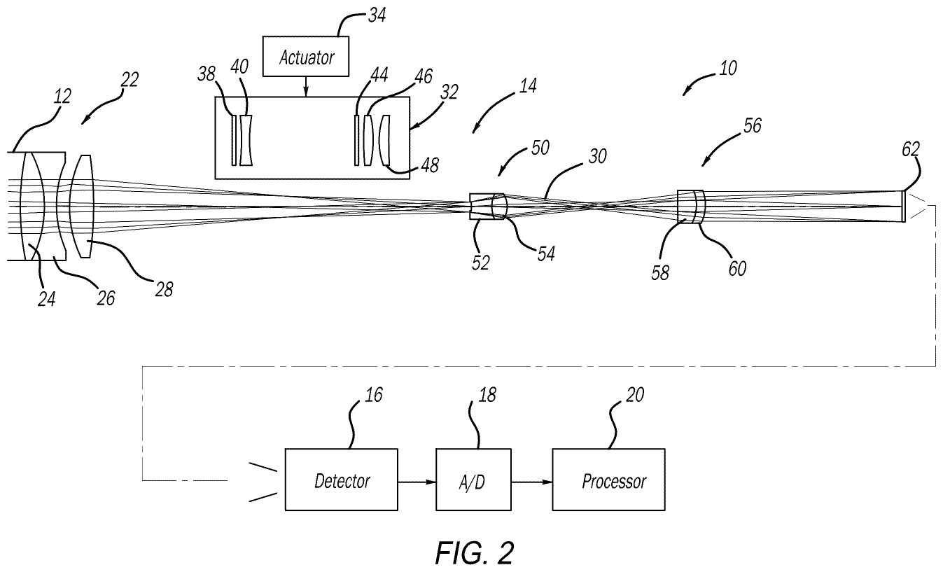

A swappable FOV lens module 32 is positioned just behind the intermediate focus of the lens group 22 in this implementation and receives the intermediate focused light beam 30 therefrom. The lens module 32 is moveable by an actuator 34 into and out of the optical axis to allow the telescope 10 to be switched between a wide FOV mode and a narrow FOV mode. The actuator 34 can be any mechanical device including motors, servos, etc. suitable for the purposes discussed herein. FIG. 2 is an illustration of the telescope 10 showing the lens module 32 removed from the optical axis by the actuator 34, where the focus of the light beam 30 is adjusted accordingly.

The configuration and focusing of the lenses within the lens module 32 could be such that when the lens module 32 is in the optical path of the beam 30, the telescope 10 is in the wide FOV mode, and when the lens module 32 is not in the optical path of the beam 30, the telescope 10 is in the narrow FOV mode. Likewise, the configuration and focusing of the lenses within the lens module 32 could be such that when the lens module 32 is in the optical path of the beam 30, the telescope 10 is in the narrow FOV mode, and when the lens module 32 is not in the optical path of the beam 30, the telescope 10 is in the wide FOV mode. In this non-limiting embodiment, the swappable FOV lens module 32 includes a forward hybrid lens group 36 having two lenses, namely, a planar metalens 38 and a concave refractive lens 40, and a rearward hybrid lens group 42 having three lenses, namely, a planar metalens 44, a convex refractive lens 46 and a convex refractive lens 48, that operate to change the focal length of the beam 30. It is noted that other telescope designs may include other numbers and configurations of lenses in the module 32 consistent with the discussion herein. By incorporating the metalenses 38 and 44 into the module 32 the weight of the module 32 can be reduced over those known in the art, which allows the actuator 34 to more quickly and reliably move the module 32 into and out of the optical axis of the telescope 10. In other words, providing lighter and smaller lenses in the module 32 allows the support structures, metering devices, servomotors, etc. to be smaller, which in turn reduces power requirements, heat, etc.

The focused light beam 30 from the module 32 is then reimaged by a lens group 50 including a refractive lens 52 and a convex refractive lens 54 and a lens group 56 including a refractive convex lens 58 and a refractive concave lens 60 onto the focal plane 62. The lens groups 50 and 56 would likely be part of the same optical module, where the lenses 52 and 54 could be optically cemented together and the lenses 58 and 60 could be optically cemented together.

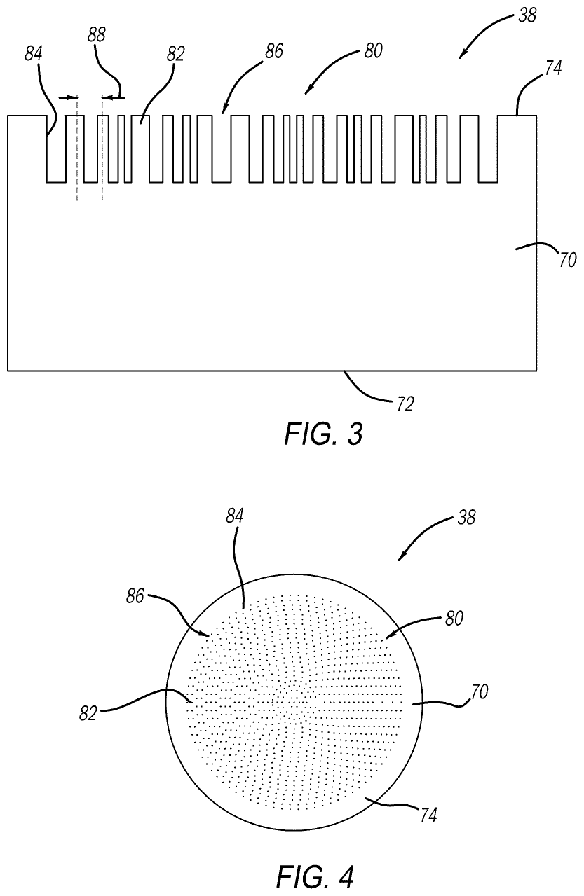

FIG. 3 is a side view and FIG. 4 is a rear view of the metalens 38 separated from the module 32 with the understanding that the metalens 44 is the same or similar. The metalens 38 includes a substrate 70 having a thickness depending on the particular application and the mechanical integrity required, and may be in the range of 200 nm to 1 mm, for example. The substrate 70 includes a front surface 72 facing the lens 28 and a rear surface 74 facing the lens 40, where the surfaces 72 and 74 are perpendicular to the propagation direction of the beam 30 along the optical axis. In an alternate embodiment, the surfaces 72 and 74 could be curved. The substrate 70 can be made of a single material or may be layered with different materials, where those materials would also depend on the particular application. For example, if the telescope 10 is imaging visible light, the material may be glass or any material that is transparent in the visible regime, and if the telescope 10 is imaging infrared light, the material may be silicon, germanium, gallium arsenide, zinc selenide, zinc, sulfide, calcium fluoride, other III-V semiconductor materials, or any material that is transparent in the IR regime.

The metalens 38 includes a metastructure 80 that can be interpreted as Fresnel zones 82 each having a series of spaced apart meta-atoms, here circular holes 84, that are etched a certain distance into the rear surface 74 of the substrate 70. The metastructure 80 causes the light to be diffracted in various controlled directions depending on where material exists and where material has been removed to obtain the desired focusing effect. The metastructure 80 is designed so that the configuration, i.e., the size and position, of the holes 84 in a radial direction provides the desired phase and thus the desired beam profile. Providing the etched holes 84 instead of extended metaelements, such as pillars, may improve the dispersion of the light and increase bandwidth, where the meta-atom can take on more complex motifs in other designs, such as multilayer features. Alternately, the holes 84 can be etched into the front surface 72 of the substrate 70, or both of the surfaces 72 and 74. The metastructure 80 can also be applied onto the substrate 70 by a polymer transfer technique. The circular configuration of identical meta-atoms with the same radial distance from the center of the substrate 70 shown as annulus 86 is adjacent to a neighboring annulus 86 with meta-atoms that are identical to each other and could be different or identical to the neighboring annulus'meta-atoms. Each Fresnel zone 82 may contain one or many of these annuli.

The lattice constant of a unit cell (meta-atom) 88 has an X and Y dimension that is on the order of ¼ of the wavelength λ of the light being imaged. The size of the holes 84, the shape of the holes 84, the size of the unit cells 88, etc. are all application specific to provide the desired beam phase changes and aberration correction for the particular application and beam wavelength. The unit cells 88 provide a possible range of transmission/reflection phases that range from 0 to 2π, which is a function of operating wavelength, selected material, meta-atom lattice constant and etch depth, shape, size and incident light properties, such as polarization and angle of incidence.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A telescope comprising:
a primary lens assembly including at least one lens, said primary lens assembly being operable to collect and focus a light beam along an optical axis;
a swappable field-of-view (FOV) lens module positioned along the optical axis, said swappable FOV lens module including a hybrid FOV lens assembly having a plurality of lenses that are operable to focus the light beam, wherein at least one of the plurality of lenses in the swappable FOV lens module is a planar metalens;
an actuator operable to move the swappable FOV lens module into and out of the optical axis to put the telescope into a wide FOV mode when the FOV lens module is in the optical axis and into a narrow FOV mode when the FOV lens module is not in the optical axis, or put the telescope into a narrow FOV mode when the FOV lens module is in the optical axis and into a wide FOV mode when the FOV lens module is not in the optical axis; and
a secondary lens assembly including at least one lens, said secondary lens assembly being operable to collect and focus the light beam from the primary lens assembly when the FOV lens module is not in the optical axis and focus the light beam from the FOV lens module when the FOV lens module is in the optical axis.

2. The telescope according to claim 1 wherein the hybrid FOV lens assembly includes a plurality of metalenses and a plurality of refractive lenses.

3. The telescope according to claims 2 wherein the hybrid FOV lens assembly includes a forward group of lenses including one metalens and one refractive lens and a rearward group of lenses including one metalens and two refractive lenses.

4. The telescope according to claim 1 wherein the hybrid FOV lens assembly includes only metalenses.

5. The telescope according to claim 1 wherein the secondary lens assembly includes a forward group of lenses including two refractive lenses and a rearward group of lenses including two refractive lenses.

6. The telescope according to claim 1 wherein the secondary lens assembly is a reimaging lens assembly.

7. The telescope according to claim 1 wherein the at least one metalens includes a metastructure having concentric spaced apart annuli where each annulus includes spaced apart holes or pillars etched into a substrate.

8. The telescope according to claim 7 wherein the holes or pillars are circular.

9. The telescope according to claim 7 wherein the metastructure is formed on an upstream surface of the substrate.

10. The telescope according to claim 7 wherein the metastructure is formed on a downstream surface of the substrate.

11. The telescope according to claim 7 wherein the metastructure is formed on both an upstream and downstream surface of the substrate.

12. The telescope according to claim 1 wherein the telescope is configured to image visible light.

13. The telescope according to claim 1 wherein the telescope is configured to image infrared light.

14. A telescope comprising:
a lens assembly including at least one lens, said lens assembly being operable to collect and focus a light beam along an optical axis;
a swappable field-of-view (FOV) lens module positioned along the optical axis, said swappable FOV lens module including a hybrid FOV lens assembly having a plurality of metalenses and a plurality of refractive lenses that are operable to focus the light beam; and
an actuator operable to move the swappable FOV module into and out of the optical axis to put the telescope into a wide FOV mode when the FOV lens module is in the optical axis and into a narrow FOV mode when the FOV lens module is not in the optical axis, or put the telescope into a narrow FOV mode when the FOV lens module is in the optical axis and into a wide FOV mode when the FOV lens module is not in the optical axis.

15. The telescope according to claims 14 wherein the hybrid FOV lens assembly includes a forward group of lenses including one metalens and one refractive lens and a rearward group of lenses including one metalens and two refractive lenses.

16. The telescope according to claim 14 wherein each of the metalenses includes a metastructure having concentric spaced apart annuli where each annulus includes spaced apart holes or pillars etched into a substrate.

17. The telescope according to claim 16 wherein the holes or pillars are circular.

18. The telescope according to claim 16 wherein the metastructure is formed on an upstream surface of the substrate.

19. The telescope according to claim 16 wherein the metastructure is formed on a downstream surface of the substrate.

20. The telescope according to claim 16 wherein the metastructure is formed on both an upstream and downstream surface of the substrate.
